(19) United States
(12) Patent Application Publication
(10) Pub. No.: US 2026/0324606 A1
(43) Pub. Date: Oct. 22, 2026

(54) AQUACULTURE WAVE MAKER

(71) Applicant: Chih-Yi LIN, Taipei City (TW)

(72) Inventor: Chih-Yi LIN, Taipei City (TW)

(21) Appl. No.: 19/555,940

(22) Filed: Mar. 4, 2026

(30) Foreign Application Priority Data
Apr. 22, 2025 (TW) 114115180

(51) Int. Cl. A01K 63/04

(52) U.S. Cl. CPC A01K 63/047

(57) ABSTRACT

An aquaculture wave maker comprises a fixed frame; a protective box on an upper end of the fixed frame, the protective box having a fixing plate carrying a linear motor coupled to a driving device; a lifting rod connected to the driving device and extending through the fixed frame and a bottom of the protective box; a wave-making plate, which is a housing, at a lower end of the lifting rod; at least one positioning guide block inside the protective box; a protective frame at a lower end of the fixed frame with at least one aperture; and a bubble-generating plate at a middle section of the lifting rod, the bubble-generating plate having a plurality of perforations each provided with a mesh. The wave-making plate and the bubble-generating plate generate waves and dissolve oxygen into water, thereby promoting upward movement of sediment and synchronizing wave generation with oxygen dissolution.

### BACKGROUND OF THE INVENTION

### Field of the Invention

The present disclosure relates to a wave maker, and more particularly to an aquaculture wave maker in which a linear motor drives a driving device to synchronously move a wave-making plate and a bubble-generating plate up and down.

### Description of the Related Art

Conventionally, culture tanks or culture ponds commonly available on the market do not have any device disposed therein for simulating natural tides. Instead, a directional pressurized water pipe is used to continuously introduce a water stream into the culture tank or the culture pond for circulation. The water stream from the pressurized water pipe merely generates turbulent flow, but does not cause wave generation in the culture tank or the culture pond. As a result, organisms cultured in the culture tank or the culture pond are not forced to exercise by wave action. When the organisms do not exercise, their feeding becomes slower; and when the organisms do not exercise, their physical condition naturally deteriorates and they become unhealthy. Further, the water stream introduced by the pressurized water pipe only generates turbulent flow, which causes many corners of the culture tank or the culture pond to be unreachable by the water flow, thereby creating numerous dead zones. A large amount of biological feces or feed accumulates as sediment at the bottom of the culture tank or the culture pond, and cannot be carried upward to circulate for filtration. Accordingly, the cultivator must frequently scoop up the organisms, replace the water in the culture tank or the culture pond, and perform cleaning, which is time-consuming and labor-intensive. The dirty sediment deposited at the bottom readily causes the cultured organisms to become ill. In addition, conventional use of the culture tank or the culture pond further requires preparing a paddle wheel aerator that consumes power and still cannot effectively dissolve oxygen into the water, thereby greatly reducing practical utility. This is an aspect that industry operators and consumers are eager to overcome.

### SUMMARY OF THE INVENTION

In order to address the foregoing deficiencies of the conventional art, a primary object of the present disclosure is to provide an aquaculture wave maker that includes a fixed frame, a protective box, a lifting rod, and a wave-making plate. A bubble-generating plate is disposed at a middle section of the lifting rod and is provided with a plurality of perforations, wherein each of the perforations is provided with a mesh and has mesh openings. A protective frame that surrounds the lifting rod, the wave-making plate, and the bubble-generating plate is disposed at a lower end of the fixed frame, thereby overcoming difficulties in the conventional art.

A secondary object of the present disclosure is to provide an aquaculture wave maker in which a driving device drives a lifting rod and a wave-making plate to move up and down, and the wave-making plate disposed in water generates waves. The bubble-generating plate is moved up and down to cut air into the water, thereby improving dissolved oxygen in the water and generating waves.

Another object of the present disclosure is to provide an aquaculture wave maker that effectively improves ease of use and enables sediment to automatically float upward for circulation and filtration.

The problem to be solved by the present disclosure is that, conventionally, culture tanks or culture ponds commonly available on the market use a directional pressurized water pipe such that a water stream continuously flows into the culture tank or the culture pond for circulation. The water stream from the pressurized water pipe merely generates turbulent flow, but does not generate waves, thereby resulting in many dead zones in the culture tank or the culture pond. A large amount of biological feces or feed accumulates as sediment at the bottom of the culture tank or the culture pond, which requires frequent water replacement and cleaning. The sediment readily causes the cultured organisms to become ill. Further, the culture tank or the culture pond must be additionally equipped with a power-consuming paddle wheel aerator that cannot effectively dissolve oxygen into the water, thereby greatly reducing practical utility.

As a technical means for solving the problems and for achieving the foregoing objectives, the present disclosure provides an aquaculture wave maker, including:
a fixed frame;
a protective box disposed on an upper end of the fixed frame, wherein a fixing plate is provided at a center of an upper inner section of the protective box, and the fixing plate is provided with a linear motor and connected to a driving device;
a lifting rod, an upper end of which is connected to the driving device of the protective box and which extends through the fixed frame and a bottom of the protective box;
a wave-making plate, which is a housing and is connected and disposed at a lower end of the lifting rod; and
wherein the driving device drives the lifting rod and the wave-making plate to move up and down, and the wave-making plate is disposed in water to generate waves.

In the aquaculture wave maker of the present disclosure, the driving device is a crankshaft, an electronic pull rod, or a screw rod.

In the aquaculture wave maker of the present disclosure, at least one positioning guide block is disposed inside the protective box to constrain the lifting rod to linear movement.

In the aquaculture wave maker of the present disclosure, the fixed frame is fixedly disposed at one side of a culture tank or a culture pond.

In the aquaculture wave maker of the present disclosure, a protective frame is disposed at a lower end of the fixed frame and surrounds the lifting rod and the wave-making plate, and the protective frame is provided with at least one aperture.

In the aquaculture wave maker of the present disclosure, the aperture of the protective frame is provided with at least one water-permeable protective cover, and the water-permeable protective cover is a mesh net or a fence.

In the aquaculture wave maker of the present disclosure, a bubble-generating plate is disposed at a middle section of the lifting rod, the bubble-generating plate is provided with a plurality of perforations, and each of the perforations is provided with a mesh and has a plurality of mesh openings.

In the aquaculture wave maker of the present disclosure, the wave-making plate is a housing and has a semicircular arc shape, a geometric shape, or an irregular shape.

In the aquaculture wave maker of the present disclosure, the bubble-generating plate is a housing and has a semicircular arc shape, a geometric shape, or an irregular shape.

In contrast to the efficacy achieved by the prior art, the aquaculture wave maker of the present disclosure includes the fixed frame, the protective box, the lifting rod, and the wave-making plate; the bubble-generating plate is disposed at the middle section of the lifting rod and has the perforations, wherein each of the perforations is provided with the mesh and has the mesh openings; and the protective frame is disposed at the lower end of the fixed frame and surrounds the lifting rod, the wave-making plate, and the bubble-generating plate. Accordingly, the driving device drives the lifting rod and the wave-making plate to move up and down, and the wave-making plate disposed in water generates waves; the bubble-generating plate moves up and down to cut air into the water, thereby improving dissolved oxygen in the water and generating waves. Ease of use is effectively enhanced, and sediment automatically floats upward for circulating filtration, thereby substantially expanding industrial applicability and providing novelty and nonobviousness.

### BRIEF DESCRIPTION OF THE DRAWINGS

FIG. 1 is an exploded perspective view of the aquaculture wave maker of the present disclosure.

FIG. 2 is an assembled perspective view of the aquaculture wave maker of the present disclosure.

FIG. 3 is an assembled cross-sectional view of the aquaculture wave maker of the present disclosure.

FIG. 4 is a schematic view illustrating the aquaculture wave maker of the present disclosure disposed at one side of a culture tank or a culture pond.

FIG. 5 is a schematic view illustrating a culture tank or a culture pond containing water, organisms, and plants, and illustrating that the linear motor and the driving device synchronously drive the lifting rod, the wave-making plate, and the bubble-generating plate to move up and down to generate waves and dissolve oxygen into the water.

### DESCRIPTION OF THE PREFERRED EMBODIMENTS

The present disclosure is described in detail below with reference to the accompanying drawings and by way of embodiments. The drawings used herein are intended solely for schematic purposes and are auxiliary to the Specification, and do not necessarily represent the actual scale and precise arrangement after implementation of the present disclosure. Accordingly, it is hereby stated that the scope of the present disclosure in actual implementation should not be construed as limited by the proportions and arrangement relationships shown in the accompanying drawings.

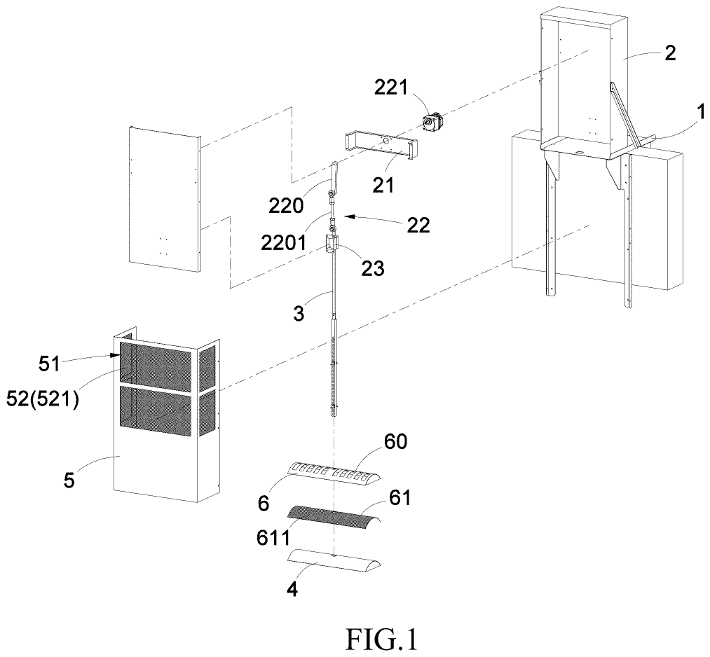

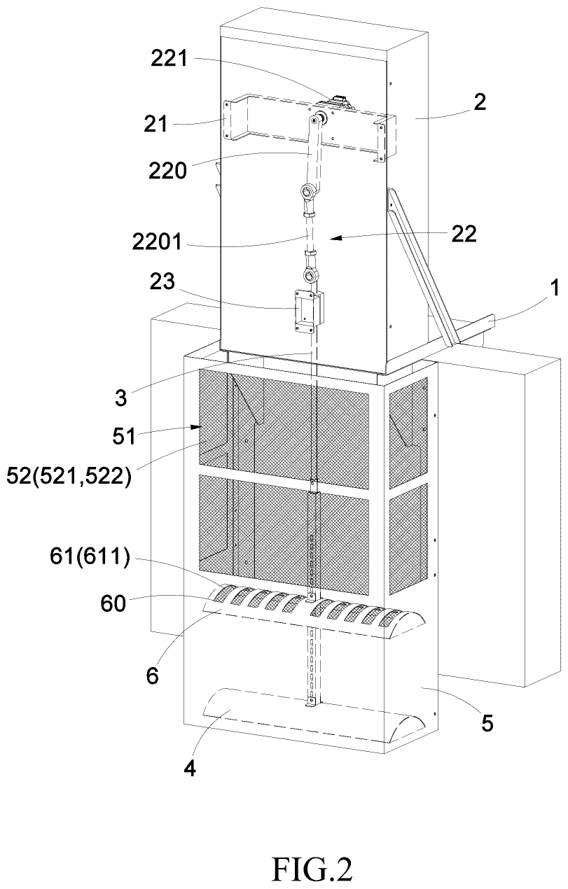

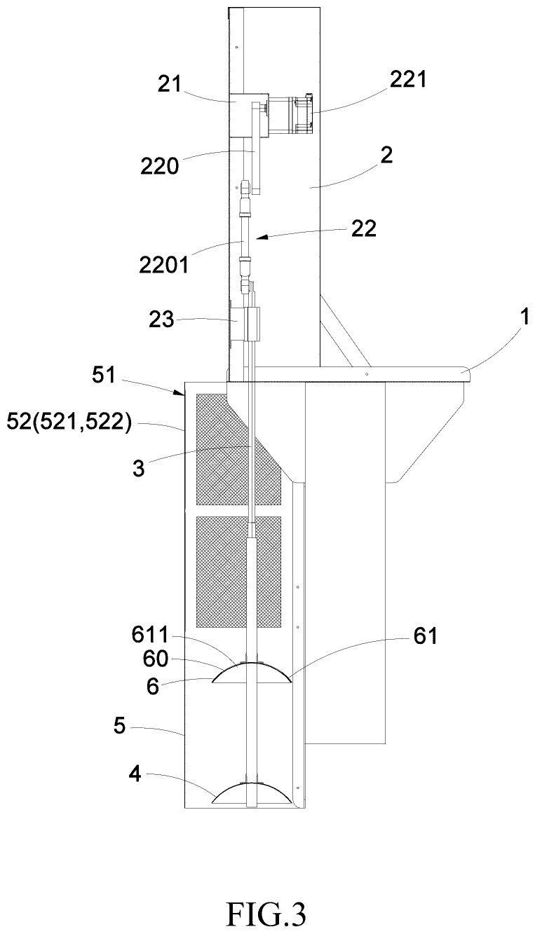

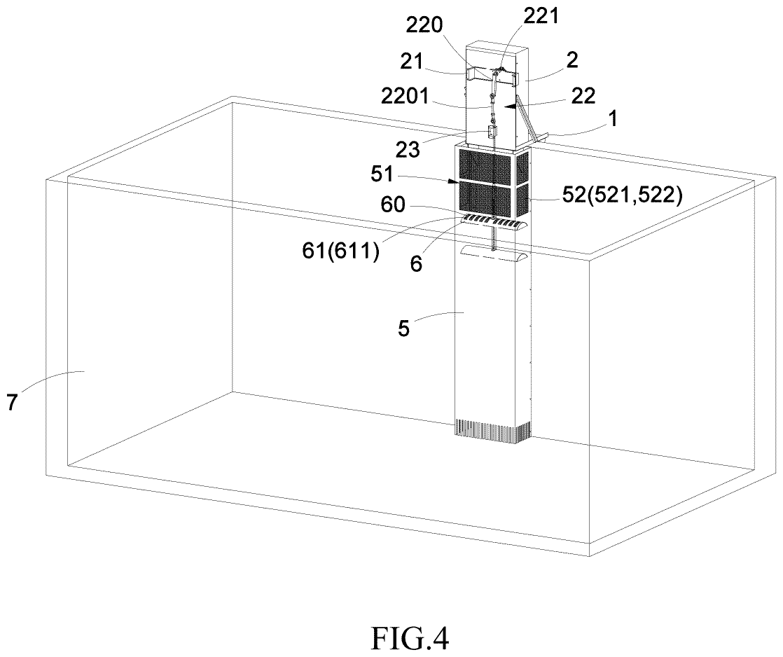

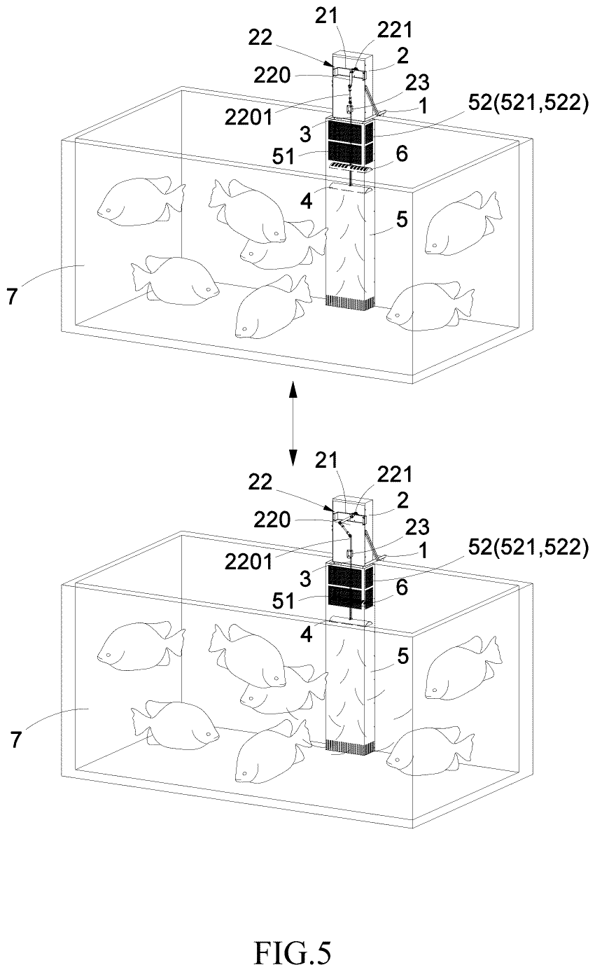

With reference to FIGS. 1-5, FIG. 1 is an exploded perspective view of the aquaculture wave maker of the present disclosure; FIG. 2 is an assembled perspective view of the aquaculture wave maker of the present disclosure; FIG. 3 is an assembled cross-sectional view of the aquaculture wave maker of the present disclosure; FIG. 4 is a schematic view illustrating the aquaculture wave maker of the present disclosure disposed at one side of a culture tank or a culture pond; and FIG. 5 is a schematic view illustrating a culture tank or a culture pond containing water, organisms, and plants, and illustrating that the linear motor and the driving device synchronously drive the lifting rod, the wave-making plate, and the bubble-generating plate to move up and down to generate waves and dissolve oxygen into the water. In a preferred embodiment, the aquaculture wave maker of the present disclosure includes a fixed frame 1, a protective box 2, a lifting rod 3, and a wave-making plate 4.

The fixed frame 1 described above is shown in FIGS. 1-3.

The protective box 2 described above is disposed on an upper end of the fixed frame 1. A fixing plate 21 is provided at a center of an upper inner section of the protective box 2, and the fixing plate 21 is provided with a linear motor 221 and connected to a driving device 22. The driving device 22 is a crankshaft, an electronic pull rod, or a screw rod, but the present disclosure is not limited thereto (as shown in FIGS. 1-3).

The lifting rod 3 described above has an upper end connected to the driving device 22 of the protective box 2 and extends through the fixed frame 1 and the bottom of the protective box 2. At least one positioning guide block 23 is disposed inside the protective box 2 to constrain the lifting rod 3 to linear movement. In this embodiment, the linear motor 221 is a motor, but the present disclosure is not limited thereto. In this embodiment, the driving device 22 is a crankshaft. The crankshaft includes a first crank rod 220 coupled to the linear motor 221 (which may be a motor) and a second crank rod 2201 connecting the first crank rod 220 and the lifting rod 3, but the present disclosure is not limited thereto. Specifically, rotation of the first crank rod 220 drives the second crank rod 2201 to perform a fan-shaped swinging motion with up-and-down and left-and-right movements, thereby pulling the lifting rod 3 connected to the second crank rod 2201 to move linearly up and down (as shown in FIGS. 1-3).

The wave-making plate 4 described above is a housing and is connected to and disposed at the lower end of the lifting rod 3. The lifting rod 3 is disposed at the center or one side of the wave-making plate 4, but the present disclosure is not limited thereto. The housing of the wave-making plate 4 has a semicircular arc shape, and may alternatively have a geometric shape or an irregular shape, but the present disclosure is not limited thereto (as shown in FIGS. 1-3).

The fixed frame 1 of the present disclosure is fixedly disposed at one side of a culture tank or a culture pond 7, and the lifting rod 3 and the wave-making plate 4 are disposed in water contained in the culture tank or the culture pond 7 (as shown in FIG. 4). The wave-making plate 4 may have various shapes to generate different waves, and different types and intensities of waves may also be generated by adjusting the size of the wave-making plate 4 and the lifting frequency. A protective frame 5 is disposed at the lower end of the fixed frame 1 and surrounds the lifting rod 3 and the wave-making plate 4, and the protective frame 5 is provided with at least one aperture 51. The aperture 51 of the protective frame 5 of the present disclosure is provided with at least one water-permeable protective cover 52. The water-permeable protective cover 52 is a mesh net 521 or a fence 522, but the present disclosure is not limited thereto (as shown in FIGS. 1-3). The water-permeable protective cover 52 is made of a metallic material or a non-metallic material. The metallic material may be stainless steel, iron, aluminum, or an alloy, but the present disclosure is not limited thereto. The non-metallic material may be plastic, wood, or plastic steel, but the present disclosure is not limited thereto. The driving device 22 drives the lifting rod 3 and the wave-making plate 4 to move up and down, and the wave-making plate 4 disposed in water generates waves.

In the aquaculture wave maker of the present disclosure, a bubble-generating plate 6 is disposed at the middle section of the lifting rod 3. The bubble-generating plate 6 is provided with a plurality of perforations 60, and each of the perforations 60 is provided with a mesh 61 and has a plurality of mesh openings 611. The bubble-generating plate 6 is enclosed within the interior of the protective frame 5. In this embodiment, the mesh 61 having the mesh openings 611 is in a semi-air-permeable and semi-water-permeable state, and the mesh 61 is made of high-density stainless steel, but the present disclosure is not limited thereto (as shown in FIGS. 1-3). When the bubble-generating plate 6 performs a reciprocating motion, the bubble-generating plate 6 leaves the water surface and then enters the water. When moving downward after leaving the water surface, the bubble-generating plate 6 cuts air into the water. Through repeated up-and-down reciprocating operation, the bubble-generating plate 6 cuts bubbles introduced into the water into increasingly finer bubbles, thereby improving dissolved oxygen in the water contained in the culture tank or the culture pond 7, and being capable of replacing the efficacy of a paddle wheel aerator of at least 750 W (watts). The bubble-generating plate 6 is a housing and has a semicircular arc shape, and may alternatively have a geometric shape or an irregular shape, but the present disclosure is not limited thereto.

With reference to FIG. 5, during use of the present disclosure, the fixed frame 1 is disposed at one side of the culture tank or the culture pond 7 containing water, the protective box 2 is disposed at the upper end of the culture tank or the culture pond 7, and the protective frame 5 is located inside the culture tank or the culture pond 7. The upper section of the lifting rod 3 is located at the upper end of the culture tank or the culture pond 7, and the middle section and the lower section of the lifting rod 3, the wave-making plate 4, and the bubble-generating plate 6 are placed into the water contained in the culture tank or the culture pond 7. The linear motor 221 on the fixing plate 21 inside the protective box 2 drives the driving device 22 to rotate. When the lifting rod 3, the wave-making plate 4, and the bubble-generating plate 6 move downward, the wave-making plate 4 presses water in the culture tank or the culture pond 7 upward. When the lifting rod 3 and the wave-making plate 4 move upward, water surrounding the wave-making plate 4 is driven upward to generate waves. Furthermore, the bubble-generating plate 6 disposed at the middle section and moving up and down synchronously with the lifting rod 3 is driven as the linear motor 221 drives the driving device 22 to rotate, such that the bubble-generating plate 6 rises with the lifting rod 3 to leave the water surface of the culture tank or the culture pond 7, and when the bubble-generating plate 6 descends with the lifting rod 3, air is pressed downward into the water of the culture tank or the culture pond 7. At this time, the air and the water are cut by the mesh openings 611 of the mesh 61 to generate a plurality of bubbles and to dissolve oxygen into the water. At the same time, when the wave-making plate 4 presses the water containing air in the culture tank or the culture pond 7 upward, and when the bubble-generating plate 6 moves upward, water containing air is cut by the mesh openings 611 of the mesh 61 of the bubble-generating plate 6, and water containing air around the bubble-generating plate 6 is driven upward, thereby also generating waves. In this manner, repeated cutting improves dissolved oxygen in the water contained in the culture tank or the culture pond 7.

Advantages of the present disclosure:
(1) The wave-making plate 4 may have various configurations to generate different wave patterns, and different intensities and types of waves may also be generated by adjusting the size of the wave-making plate 4 and the operating frequency.
(2) The bubble-generating plate 6 may have various configurations. In addition to cutting air into the water, the bubble-generating plate 6 can improve dissolved oxygen in the water and generate different wave patterns.
(3) The wave-making plate 4 and the bubble-generating plate 6 may be connected to the driving device 22 by different types of the linear motor 221.
(4) The lifting rod 3, the wave-making plate 4, and the bubble-generating plate 6 of the present disclosure may be additionally provided with the protective frame 5 having at least one aperture 51, and the aperture 51 is provided with the water-permeable protective cover 52 to protect organisms approaching the aquaculture wave maker from injury.
(5) Organisms cultured in the culture tank or the culture pond 7 are forced to move due to wave generation, thereby increasing feeding speed and naturally improving physical health.
(6) Water in the culture tank or the culture pond 7 does not generate turbulence and has no dead zones. A large amount of organism feces or feed does not settle at the bottom of the culture tank or the culture pond 7, and automatically floats upward for circulating filtration.
(7) The culture tank or the culture pond 7 does not require frequent water replacement and cleaning, thereby saving time and labor. Because there is no dirty sediment at the bottom, cultured organisms are less likely to become ill.
(8) Due to wave generation, water in the culture tank or the culture pond 7 causes plants provided therein to sway more dynamically.
(9) Waves can be generated synchronously with the dissolution of oxygen from the air into the water.

The present disclosure includes the fixed frame 1, the protective box 2, the lifting rod 3, and the wave-making plate 4; the bubble-generating plate 6 is disposed at the middle section of the lifting rod 3 and has the perforations 60, wherein each of the perforations 60 is provided with the mesh 61 and has the mesh openings 611; and the protective frame 5 is disposed at the lower end of the fixed frame 1 and surrounds the lifting rod 3, the wave-making plate 4, and the bubble-generating plate 6. Accordingly, the driving device 22 drives the lifting rod 3 and the wave-making plate 4 to move up and down, and the wave-making plate 4 disposed in water generates waves; the bubble-generating plate 6 moves up and down to cut air into the water, thereby improving dissolved oxygen in the water and generating waves. Ease of use is effectively enhanced, and sediment automatically floats upward for circulating filtration, thereby substantially expanding industrial applicability and providing novelty and nonobviousness.

In view of the foregoing, the present disclosure overcomes the prior art and indeed achieves the intended improvements in efficacy, and is not readily conceived by a person having ordinary skill in the art. Furthermore, the present disclosure was not disclosed prior to filing. Accordingly, the novelty and nonobviousness thereof satisfy the requirements for patentability. Applicant respectfully submits the present application in accordance with applicable law and requests that the Office allow the present application in order to encourage invention.

The embodiments described above are merely illustrative of the technical concepts and features of the present disclosure and are intended to enable a person having ordinary skill in the art to understand and implement the present disclosure. The present disclosure is not limited to such embodiments. Any equivalent changes or modifications made in accordance with the spirit disclosed herein shall fall within the scope of the present disclosure.

What is claimed is:

1. An aquaculture wave maker, comprising:
a fixed frame;
a protective box disposed on an upper end of the fixed frame, wherein a fixing plate is provided at a center of an upper inner section of the protective box, and the fixing plate is provided with a linear motor and connected to a driving device;
a lifting rod, an upper end of which is connected to the driving device of the protective box and which extends through the fixed frame and a bottom of the protective box;
a wave-making plate, which is a housing and is connected and disposed at a lower end of the lifting rod; and
wherein the driving device drives the lifting rod and the wave-making plate to move up and down, and the wave-making plate is disposed in water to generate waves.

2. The aquaculture wave maker according to claim 1, wherein the driving device is a crankshaft, an electronic pull rod, or a screw rod.

3. The aquaculture wave maker according to claim 1, wherein at least one positioning guide block is disposed inside the protective box to constrain the lifting rod to linear movement.

4. The aquaculture wave maker according to claim 3, wherein the fixed frame is fixedly disposed at one side of a culture tank or a culture pond.

5. The aquaculture wave maker according to claim 3, wherein a protective frame is disposed at a lower end of the fixed frame and surrounds the lifting rod and the wave-making plate, and the protective frame is provided with at least one aperture.

6. The aquaculture wave maker according to claim 5, wherein the aperture of the protective frame is provided with at least one water-permeable protective cover, and the water-permeable protective cover is a mesh net or a fence.

7. The aquaculture wave maker according to claim 1, wherein a bubble-generating plate is disposed at a middle section of the lifting rod, the bubble-generating plate is provided with a plurality of perforations, and each of the perforations is provided with a mesh and has a plurality of mesh openings.

8. The aquaculture wave maker according to claim 6, wherein a bubble-generating plate is disposed at a middle section of the lifting rod, the bubble-generating plate is provided with a plurality of perforations, and each of the perforations is provided with a mesh and has a plurality of mesh openings.

9. The aquaculture wave maker according to claim 1, wherein the wave-making plate is a housing and has a semicircular arc shape, a geometric shape, or an irregular shape.

10. The aquaculture wave maker according to claim 8, wherein the bubble-generating plate is a housing and has a semicircular arc shape, a geometric shape, or an irregular shape.
